(19) United States
(12) Patent Application Publication
(10) Pub. No.: US 2021/0197758 A1
(43) Pub. Date: Jul. 1, 2021

(54) SYSTEMS AND METHODS FOR A HINGED HOOD LIFTER

(71) Applicant: Joyson Safety Systems Acquisition LLC, Auburn Hills, MI (US)

(72) Inventor: Michael Hishon, New Baltimore, MI (US)

(21) Appl. No.: 17/138,361

(22) Filed: Dec. 30, 2020

Related U.S. Application Data
(60) Provisional application No. 62/955,799, filed on Dec. 31, 2019.

(51) Int. Cl. B60R 21/38; E05D 3/12

(52) U.S. Cl. CPC B60R 21/38; E05Y 2900/536; E05Y 2201/624; E05D 3/125

(57) ABSTRACT

Various implementations include a hood lifting front hinge including a first hinge plate, second hinge plate, and third hinge plate. A first portion of the first hinge plate is hingedly coupled to a first portion of the second hinge plate. A second portion of the second hinge plate is hingedly coupled to a second portion of the third hinge plate. The first hinge plate, second hinge plate, and third hinge plate are hingedly movable from a collapsed position to an extended position. The first hinge plate is couplable to a portion of a hood latch of a vehicle and the third hinge plate is couplable to a portion of a hood of a vehicle. The hood is further from the hood latch and closer to a windshield of the vehicle when the hinge plates are in the extended position than when the hinge plates are in the collapsed position.

### CROSS-REFERENCE TO RELATED APPLICATIONS

This application claims the benefit of U.S. Provisional Patent Application No. 62/955,799, filed Dec. 31, 2019, the contents of which are incorporated herein by reference in their entirety.

### BACKGROUND

Recent government requirements for the New Car Assessment Program (“NCAP”) include pedestrian protection systems for vehicles. One of the requirements of NCAP is to lift the hood of a vehicle upwardly and away from hard points under the hood (e.g., the engine), using the hood as an energy management device to minimize head and bodily injury to a pedestrian when impacted by the vehicle. Current hood lifting systems only lift the rear portion of the hood away from the engine upon pedestrian impact. These hood lifting systems protect adults but not small children. Also, these hood lifting systems do not protect against impact with other potential hard points of contact on the vehicle, such as the cowl of the windshield.

Recent developments in hood lifting systems include four hood lifting hinges (two hinges disposed at the front portion of the hood and two hinges disposed at the rear portion of the hood) which translate the hood upwardly and rearwardly upon actuation. The upward lifting of the hood protects pedestrians, as in the earlier hood lifting systems, but the rearward translation of the hood also moves the hood away from the front of the vehicle and allows the hood to protect against impact with portions of the windshield. Prior to actuation of these hood lifting systems, the two front hinges remain disengaged so that the hood can be opened using the hood latch during normal use. Upon the event of collision with a pedestrian and prior to actuating the hood lifting system, the front hinges must be engaged and the hood latch disengaged, which can result in unreliable results and a delayed hood lift. The multiple moving parts also increase the costs of these systems.

Thus, there is a need for an economic system that reliably lifts the hood of a vehicle upwardly and rearwardly upon actuation.

### SUMMARY

Various implementations include a hood lifting front hinge. The front hinge includes a first hinge plate, a second hinge plate, and a third hinge plate. The first hinge plate has a first portion and a second portion spaced apart and opposite the first portion along a first longitudinal axis. The second hinge plate has a first portion and a second portion spaced apart and opposite the first portion of the second hinge plate along a second longitudinal axis. The first portion of the first hinge plate is hingedly coupled to the first portion of the second hinge plate. The third hinge plate has a first portion and a second portion spaced apart and opposite the first portion of the third hinge plate along a third longitudinal axis. The second portion of the second hinge plate is hingedly coupled to the second portion of the third hinge plate.

The first hinge plate, the second hinge plate, and the third hinge plate are hingedly movable from a collapsed position to an extended position. In the collapsed position, the first longitudinal axis and the second longitudinal axis are at a minimum angle to each other, and in the extended position, the first longitudinal axis and the second longitudinal axis are at a maximum angle to each other. The maximum angle is greater than the minimum angle.

The first hinge plate is couplable to a portion of a hood latch of a vehicle and the third hinge plate is couplable to a portion of a hood of a vehicle. The hood of the vehicle is further from the hood latch and closer to a windshield of the vehicle when the hinge plates are in the extended position than when the hinge plates are in the collapsed position.

In some implementations, the first hinge plate further includes a latch mounting portion structured for mounting the front hinge to the portion of the hood latch.

In some implementations, the third hinge plate further includes a hood mounting portion structured for mounting the front hinge to the hood of the vehicle.

In some implementations, at least two of the first hinge plate, the second hinge plate, and the third hinge plate include a temporary connector coupling the at least two of the first hinge plate, the second hinge plate, and the third hinge plate in the collapsed position. The temporary connector is uncoupled when the first hinge plate, the second hinge plate, and the third hinge plate are moved from the collapsed position to the extended position. In some implementations, the temporary connector is a clinched connection. In some implementations, the temporary connector is a rivet.

In some implementations, a length between the first hinged connection and the second hinged connection is selected such that the second portion of the third hinge plate is at least 100 mm away from the first longitudinal axis and is at least 50 mm parallel to the first longitudinal axis when the first, second, and third hinge plates are moved from the collapsed position to the extended position. In some implementations, the length between the first hinged connection and the second hinged connection is selected such that the second portion of the third hinge plate is at least 150 mm away from the first longitudinal axis and is at least 100 mm parallel to the first longitudinal axis when the first, second, and third hinge plates are moved from the collapsed position to the extended position.

Various other implementations include a front hinge actuation system including the front hinge described above and an actuator for moving the first hinge plate, the second hinge plate, and the third hinge plate from the collapsed position to the extended position.

Various other implementations include a hood lifting assembly. The assembly includes a single hood lifting front hinge such as the hood lifting front hinge described above, and two hood lifting rear hinges. The two hood lifting rear hinges each include at least three rear hinge plates. Each of the at least three rear hinge plates is hingedly coupled to at least one of the others of the at least three rear hinge plates. One of the at least three rear hinge plates is couplable to a portion of a body of the vehicle, and another of the at least three rear hinge plates is couplable to a rear portion of the hood of the vehicle such that the rear portion of the hood of the vehicle is further from the portion of the body of the vehicle and closer to the windshield of the vehicle in the extended position than in the collapsed position.

In some implementations, the assembly further includes a hood latch, and the portion of the hood latch to which the first hinge plate is couplable is a striker.

In some implementations, the first hinge plate further includes a latch mounting portion structured for mounting the front hinge to the portion of the hood latch.

In some implementations, the third hinge plate further includes a hood mounting portion structured for mounting the front hinge to the hood of the vehicle.

In some implementations, at least two of the first hinge plate, the second hinge plate, and the third hinge plate include a first temporary connector coupling the at least two of the first hinge plate, the second hinge plate, and the third hinge plate in the collapsed position. The first temporary connector is uncoupled when the first hinge plate, the second hinge plate, and the third hinge plate are moved from the collapsed position to the extended position. In some implementations, the first temporary connector is a clinched connection. In some implementations, the first temporary connector is a rivet.

In some implementations, the assembly further includes an actuator for moving the first hinge plate, the second hinge plate, and the third hinge plate from the collapsed position to the extended position.

In some implementations, a length between the first hinged connection and the second hinged connection is selected such that the second portion of the third hinge plate is at least 100 mm away from the first longitudinal axis and is at least 50 mm parallel to the first longitudinal axis when the first, second, and third hinge plates are moved from the collapsed position to the extended position In some implementations, the length between the first hinged connection and the second hinged connection is selected such that the second portion of the third hinge plate is at least 150 mm away from the first longitudinal axis and is at least 100 mm parallel to the first longitudinal axis when the first, second, and third hinge plates are moved from the collapsed position to the extended position.

In some implementations, the one of the at least three rear hinge plates of each of the two hood lifting rear hinges is hingedly couplable to the portion of the body of the vehicle.

In some implementations, at least two of the at least three rear hinge plates of each of the two hood lifting rear hinges include a second temporary connector coupling the at least two of the at least three rear hinge plates in the collapsed position. The second temporary connector is uncoupled when the first hinge plate, the second hinge plate, and the third hinge plate are moved from the collapsed position to the extended position. In some implementations, the second temporary connector is a clinched connection. In some implementations, the second temporary connector is a rivet.

### BRIEF DESCRIPTION OF DRAWINGS

Example features and implementations are disclosed in the accompanying drawings. However, the present disclosure is not limited to the precise arrangements and instrumentalities shown. Similar elements in different implementations are designated using the same reference numerals.

FIG. 1A shows a perspective view of a vehicle including a hood lifting assembly, in which the hood of the vehicle is in an open position, according to one implementation.

FIG. 1B shows a perspective view of the vehicle including the hood lifting assembly shown in FIG. 1A, in which the hood of the vehicle is in a closed position and the front hinge and rear hinges are in a collapsed position.

FIG. 2A shows a side detail view of the front hinge shown in FIG. 1A, in which the front hinge is in a collapsed position.

FIG. 2B shows a side detail view of the front hinge shown in FIG. 1A, in which the front hinge is in an extended position.

FIG. 3A shows a side detail view of the rear hinge shown in FIG. 1A, in which the rear hinge is in a collapsed position.

FIG. 3B shows a side detail view of the rear hinge shown in FIG. 1A, in which the rear hinge is in an extended position.

FIG. 4 shows a perspective view of the vehicle including the hood lifting assembly shown in FIG. 1A, in which the front hinge and rear hinges are in the extended position.

### DETAILED DESCRIPTION

Various implementations of the devices, systems, and methods disclosed herein provide for improved protection for pedestrians in the event of a collision with a hood of a vehicle. According to various implementations, a hinged hood lifter system includes a front hinge that is movable in an upward and rearward direction relative to the body of the vehicle when the hinged hood lifter system is actuated. In some implementations, the system may also include two rear hinges that facilitate this movement of the hood. Because the hinged hood lifter system moves the hood of the vehicle upwardly away from the engine, a pedestrian striking the relatively thin hood should not deform the hood enough to contact the much harder engine. The rearward movement of the hood as the hood is lifted decreases the chances of a child or small person from contacting the leading edge of the hood in the lifted position. The rearward movement of the hood also covers the cowl of the windshield of the car, preventing a pedestrian from striking the cowl.

Various implementations include a hood lifting front hinge. The front hinge includes a first hinge plate, a second hinge plate, and a third hinge plate. The first hinge plate has a first portion and a second portion spaced apart and opposite the first portion along a first longitudinal axis. The second hinge plate has a first portion and a second portion spaced apart and opposite the first portion of the second hinge plate along a second longitudinal axis. The first portion of the first hinge plate is hingedly coupled to the first portion of the second hinge plate. The third hinge plate has a first portion and a second portion spaced apart and opposite the first portion of the third hinge plate along a third longitudinal axis. The second portion of the second hinge plate is hingedly coupled to the second portion of the third hinge plate.

The first hinge plate, the second hinge plate, and the third hinge plate are hingedly movable from a collapsed position to an extended position. In the collapsed position, the first longitudinal axis and the second longitudinal axis are at a minimum angle to each other, and in the extended position, the first longitudinal axis and the second longitudinal axis are at a maximum angle to each other. The maximum angle is greater than the minimum angle.

The first hinge plate is couplable to a portion of a hood latch of a vehicle and the third hinge plate is couplable to a portion of a hood of a vehicle. The hood of the vehicle is further from the hood latch and closer to a windshield of the vehicle when the hinge plates are in the extended position than when the hinge plates are in the collapsed position.

Various other implementations include a hood lifting assembly. The assembly includes a single hood lifting front hinge, such as the hood lifting front hinge described above, and two hood lifting rear hinges. The two hood lifting rear hinges each include at least three rear hinge plates. Each of the at least three rear hinge plates is hingedly coupled to at least one of the others of the at least three rear hinge plates. One of the at least three rear hinge plates is couplable to a portion of a body of the vehicle, and another of the at least three rear hinge plates is couplable to a rear portion of the hood of the vehicle such that the rear portion of the hood of the vehicle is further from the portion of the body of the vehicle and closer to the windshield of the vehicle in the extended position than in the collapsed position.

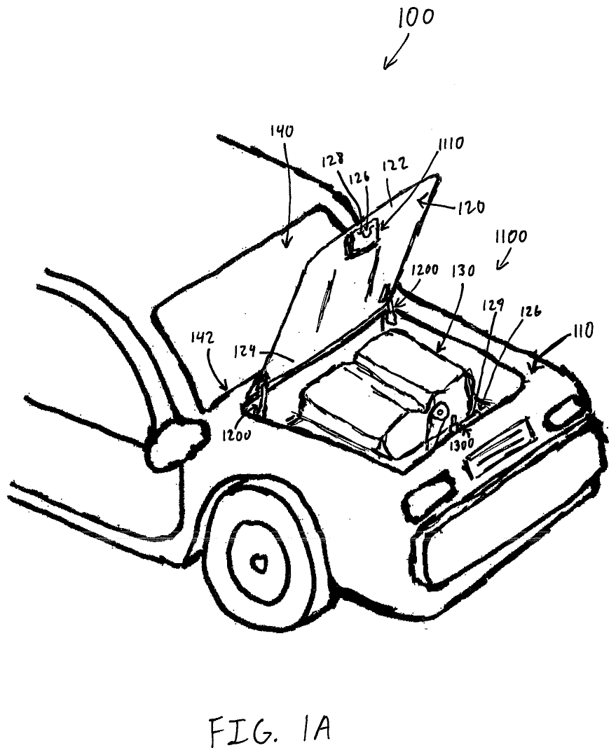

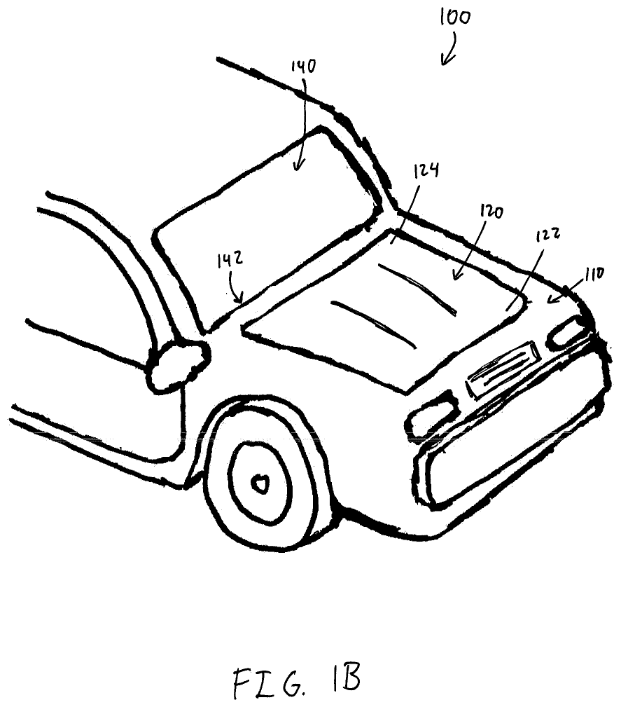

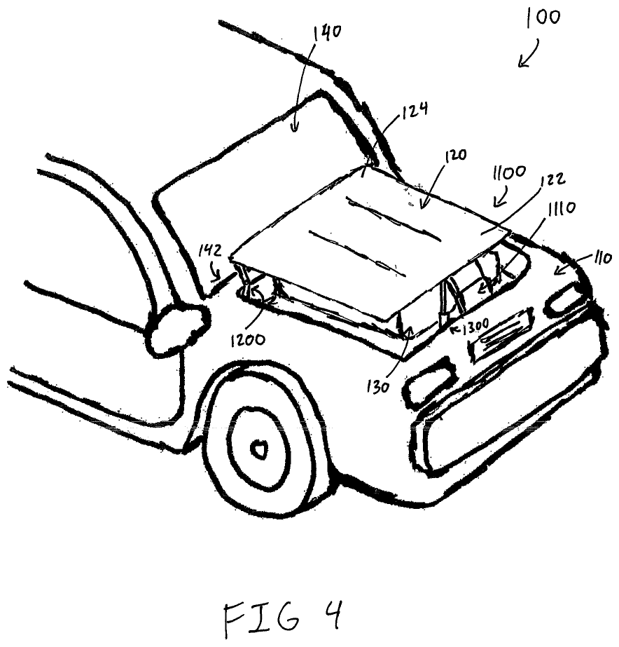

FIG. 1A shows a vehicle 100 including a hood lifting assembly 1100 in an open position, according to one implementation. FIG. 1B shows the same vehicle 100 with the hood lifting assembly 1100 in a closed position. The vehicle 100 also includes a body 110, a hood 120, an engine 130, and a windshield 140 including a cowl 142. The assembly 1100 includes a single hood lifting front hinge 1110 and two hood lifting rear hinges 1200 coupling the hood 120 of the vehicle 100 to the body 110 of the vehicle 100. The assembly 1100 also includes an actuator 1300 for moving the hood 120 from a collapsed position, as shown in FIGS. 1A and 1B, to an extended position, as shown in FIG. 4.

The rear hinges 1200 are rigidly coupled to either side of a rear portion 124 of the hood 120 of the vehicle 100 and hingedly coupled to the body 110 of the vehicle 100 to allow the hood 120 to move between the closed position and the open position. In other implementations, the rear hinges are hingedly coupled to either side of a rear portion of the hood of the vehicle and rigidly coupled to the body of the vehicle to allow the hood to move between the closed position and the open position.

The front hinge 1110 is rigidly coupled to a front portion 122 of the hood 120 of the vehicle 100. In particular, the hinge 1110 is coupled to the portion of the hood latch 126 of the vehicle 100 that is stationary relative to the hood 120 when the hood 120 is moved between the open position and the closed position. As shown in FIG. 1A, the stationary portion to which the front hinge 1110 is coupled is the striker portion 128 of the hood latch 126 of the vehicle 100. But, in other implementations, the latch portion 129 is the portion of the hood latch 126 that is stationary relative to the hood 120 when the hood 120 is moved between the open position and the closed position. In these implementations, the front hinge 1110 is coupled to the latch portion 129 of the hood latch 126. The hood latch 126 shown in FIG. 1A is disposed laterally midway along the front portion 122 of the hood 120 of the vehicle 100, and the front hinge 1110 is coupled to a portion of the hood latch 126. In other implementations, the hood latch is disposed at a location along the front portion of the hood of the vehicle such that the front hinge is also disposed in the same location along the front portion of the hood of the vehicle as the hood latch.

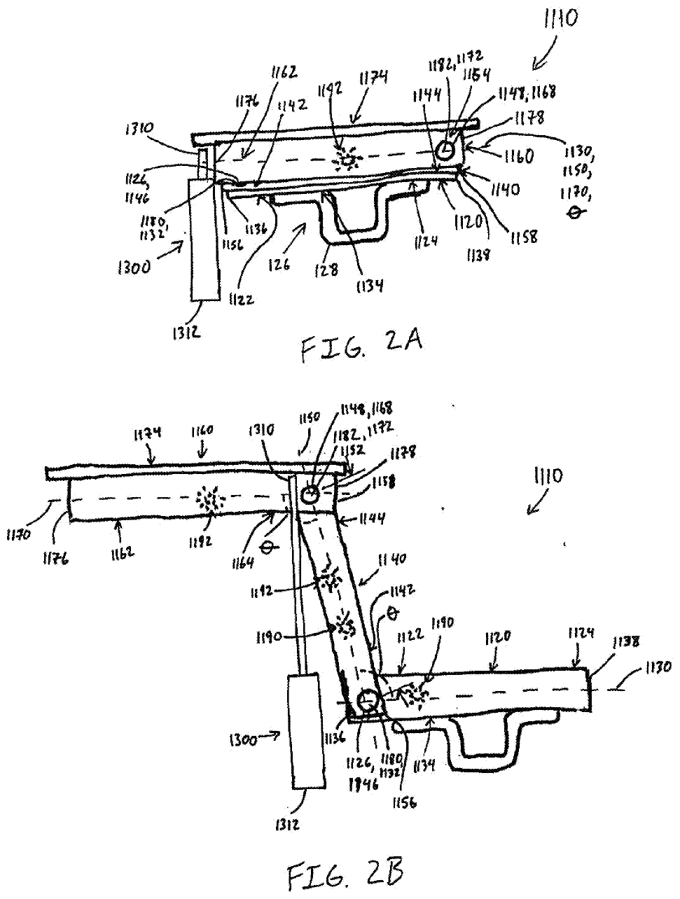

FIGS. 2A and 2B show a side, detailed view of the front hinge 1110 shown in FIG. 1A. The front hinge 1110 includes a first hinge plate 1120, a second hinge plate 1140, and a third hinge plate 1160.

The first hinge plate 1120 has a first portion 1122 and a second portion 1124. The first portion 1122 of the first hinge plate 1120 includes and extends adjacent a first edge 1136 of the first hinge plate 1120, and the second portion 1124 of the first hinge plate 1120 includes and extends adjacent a second edge 1138 of the first hinge plate 1120. The first edge 1136 and the second edge 1138 are opposite and spaced apart from each other along a first longitudinal axis 1130 that extends through the edges 1136, 1138. The first portion 1122 of the first hinge plate 1120 defines a first hinge opening 1126. The first hinge plate 1120 includes a latch mounting portion 1134 structured for mounting the front hinge 1110 to a portion of the hood latch 126. In FIG. 1A, the portion of the hood latch 126 to which the latch mounting portion 1134 of the first hinge plate 1120 is coupled is the striker portion 128 of the hood latch 126, but in other implementations, the portion of the hood latch 126 to which the latch mounting portion 1134 of the first hinge plate 1120 is coupled is the latch portion 129 of the hood latch 126. In other implementations, the first portion and the second portion of the first hinge plate do not necessarily include the first and second edges and are located and spaced apart anywhere along the first longitudinal axis.

The second hinge plate 1140 has a first portion 1142 and a second portion 1144. The first portion 1142 of the second hinge plate 1140 includes and extends adjacent a first edge 1156 of the second hinge plate 1140, and the second portion 1144 of the second hinge plate 1140 includes and extends adjacent a second edge 1158 of the second hinge plate 1140. The first edge 1156 and the second edge 1158 are opposite and spaced apart from each other along a second longitudinal axis 1150 that extends through the edges 1156, 1158. The first portion 1142 of the second hinge plate 1140 defines a first hinge opening 1146, and the second portion 1144 of the second hinge plate 1140 defines a second hinge opening 1148. In other implementations, the first portion and the second portion of the second hinge plate do not necessarily include the first and second edges and are located and spaced apart anywhere along the second longitudinal axis.

The third hinge plate 1160 has a first portion 1162 and a second portion 1164. The first portion 1162 of the third hinge plate 1160 includes and extends adjacent a first edge 1176 of the third hinge plate 1160, and the second portion 1164 of the third hinge plate 1160 includes and extends adjacent a second edge 1178 of the third hinge plate 1160. The first edge 1176 and the second edge 1178 are opposite and spaced apart from each other along a third longitudinal axis 1170 that extends through the edges 1176, 1178. The second portion 1164 of the third hinge plate 1160 defines a second hinge opening 1168. The third hinge plate 1160 includes a hood mounting portion 1174 structured for mounting the front hinge 1110 to a portion of the hood 120 of the vehicle 100. In other implementations, the first portion and the second portion of the third hinge plate do not necessarily include the first and second edges and are located and spaced apart anywhere along the third longitudinal axis.

As shown in FIGS. 2A and 2B, a first bolt 1180 extends through the first hinge opening 1126 of the first hinge plate 1120 and the first hinge opening 1146 of the second hinge plate 1140 to form a first hinged connection 1132 such that the first portion 1122 of the first hinge plate 1120 is hingedly coupled to the first portion 1142 of the second hinge plate 1140. A second bolt 1182 extends through the second hinge opening 1148 of the second hinge plate 1140 and the second hinge opening 1168 of the third hinge plate 1160 to form a second hinged connection 1172 such that the second portion 1144 of the second hinge plate 1140 is hingedly coupled to the second portion 1164 of the third hinge plate 1160. The first hinged connection 1132 of the first hinge plate 1120 and the second hinge plate 1140 and the second hinged connection 1172 between the second hinge plate 1140 and the third hinge plate 1160 are movable from the collapsed position, shown in FIG. 1B, to the extended position, shown in FIG. 4. In the collapsed position, the first longitudinal axis 1130 and the second longitudinal axis 1150 are at a minimum angle Θ to each other, as shown in FIG. 2A. For example, the minimum angle 1184 is between 0° and 10°. In the extended position, the first longitudinal axis 1130 and the second longitudinal axis 1150 are at a maximum angle Θ to each other, as shown in FIG. 2B. For example, the maximum angle 1186 is between 60° and 120°. The maximum angle 1186 is greater than the minimum angle 1184. In other implementations, a rod or other axle engages the hinge openings to create the first hinged connection and the second hinged connection. In other implementations, the first and second hinged connections are any suitable hinged connector.

Because the front hinge 1110 is coupled between the hood latch 126 and the hood 120 of the vehicle 100, the front hinge 1110 does not need to be disengaged to unlatch and move the hood 120 from the closed position to the open position or engaged before moving the front hinge 1110 from the collapsed position to the extended position, as is necessary in the prior art. This reduces the number of moving parts and complexity of the actuation of the front hinge 1110. Disposing a single front hinge 1110 between the hood latch 126 and the hood 120 of the vehicle 100, rather than including two front hinges 1110 disposed on either side of the front portion 122 of the hood 120 as practiced in the prior art, also reduces the number of front hinges 1110 and overall cost of the hood lifting assembly 1100.

The first hinge plate 1120 and the second hinge plate 1140 include a first temporary connector 1190 coupling the first hinge plate 1120 to the second hinge plate 1140 in the collapsed position. The second hinge plate 1140 and the third hinge plate 1160 include a second temporary connector 1192 coupling the second hinge plate 1140 to the third hinge plate 1160 in the collapsed position. The first temporary connector 1190 and the second temporary connector 1192 are uncoupled when the first hinge plate 1120, the second hinge plate 1140, and the third hinge plate 1160 are moved from the collapsed position to the extended position. The first temporary connector 1190 and the second temporary connector 1192 shown in FIGS. 2A and 2B are both clinched connections, but in other implementations, the first temporary connector and the second temporary connector are rivets, welds, adhesives, fasteners, or any other type of connector capable of coupling the first hinge plate, the second hinge plate, and the third hinge plate together under typical forces and vibrations exerted on the front hinge when in the collapsed position. In some implementations, the first temporary connector and the second temporary connector are different types of temporary connectors. In some implementations, only one of the first hinge plate and second hinge plate or the second hinge plate and third hinge plate include a temporary connector.

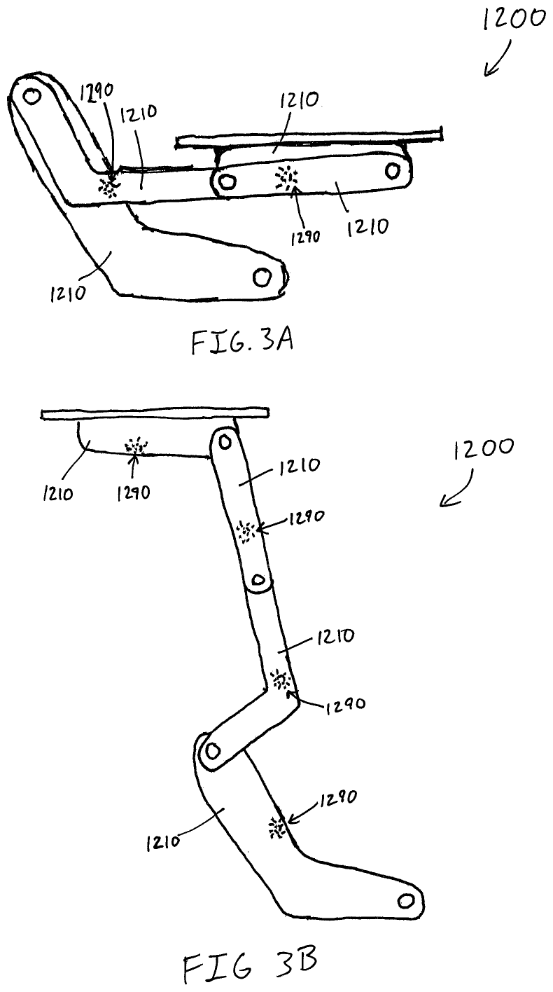

FIGS. 3A and 3B shows one of the two hood lifting rear hinges 1200 shown in FIG. 1A. Each of the two hood lifting rear hinges 1200 includes four rear hinge plates 1210. Each of the four rear hinge plates 1210 is hingedly coupled to another of the four rear hinge plates 1210 such that each of the rear hinges 1200 is movable between a collapsed position, shown in FIG. 3A, and an extended position, shown in FIG. 3B. A first rear hinge plate 1210 is coupled to a portion of a body 110 of the vehicle 100, and a second rear hinge plate 1210 is coupled to a rear portion 124 of the hood 120 of the vehicle 100. Although each of the rear hinges 1200 shown in FIGS. 3A and 3B includes four rear hinge plates 1210, in other implementations, each of the rear hinges includes three rear hinge plates, or more than four rear hinge plates, and each of the rear hinge plates included in a rear hinge is hingedly coupled to at least one other rear hinge plate.

Each of the two rear hinges 1200 include a rear temporary connector 1290 coupling two of the rear hinge plates 1210 together in the collapsed position. The rear temporary connectors 1290 are uncoupled when the two rear hinge plates 1210 on each rear hinge 1200 are moved from the collapsed position to the extended position. The rear temporary connectors 1290 shown in FIGS. 3A and 3B are both clinched connections, but in other implementations, the rear temporary connectors are rivets, welds, adhesives, fasteners, or any other type of connector capable of coupling the rear hinge plates together under typical forces and vibrations exerted on the rear hinge when in the collapsed position. In some implementations, the rear temporary connectors are different types of temporary connectors.

The actuator 1300 shown in FIGS. 1A, 2A, 2B, and 4 is a linear actuator having a first end 1310 and a second end 1312. The actuator 1300 is actuatable from a first position, shown in FIGS. 1A and 2A, to a second position, shown in FIGS. 2B and 4. The second end 1312 of the actuator 1300 is coupled to the body 110 of the vehicle 100, and the actuator 1300 is oriented such that, when the hood 120 is in the closed position, the first end 1310 of the actuator 1300 contacts and applies force to a portion of the front hinge 1110 when the actuator 1300 is actuated from the first position to the second position. As the actuator 1300 contacts and applies force to a portion of the front hinge 1110, the front hinge 1110 is moved from the collapsed position to the extended position, as discussed below. Although the first end 1310 of the actuator 1300 shown in FIG. 1A contacts a portion of the front hinge 1110 when the actuator 1300 is actuated, in other implementations, the first end of the actuator contacts and applies a force to a portion of one of the rear hinges or a portion of the hood of the vehicle when the actuator is actuated. In other implementations, the second end of the actuator is coupled to a portion of the front hinge, a portion of one of the rear hinges, or a portion of the hood of the vehicle and the first end of the actuator contacts and applies force to a portion of the body of the vehicle when the actuator is actuated. In other implementations, the assembly includes more than one actuator. Although the actuator 1300 shown in FIG. 1A is a linear actuator, in some implementations, the actuator is an inflatable device such as an airbag or pneumatic actuator.

In the implementation shown in FIGS. 1A-4, the actuator 1300 moves the front hinge 1110 from the collapsed position to the extended position. The movement of the front hinge 1110 from the collapsed position to the extended position causes the two rear hinges 1200 to also move from a collapsed position to an extended position, lifting the entire hood 120 away from the body 110 of the vehicle 100. In other implementations, one or both of the rear hinges are moved by one or more actuators from the collapsed position to the extended position, which causes the front hinge to also move from a collapsed position to an extended position. In some implementations, actuators are used to move any combination of front and rear hinges from the collapsed position to the extended position, and this movement causes the other of the front hinge and rear hinges to move from the collapsed position to the extended position.

For the front hinge 1110 shown in FIGS. 2A and 2B, a length 1152 between the first hinged connection 1132 and the second hinged connection 1172 is selected such that, when the hinge plates 1120, 1140, 1160 move from the collapsed position to the extended position, the second portion 1164 of the third hinge plate 1160 moves 100 mm in a direction perpendicular to the first longitudinal axis 1130 and 50 mm in a direction parallel to the first longitudinal axis 1130 in the direction of the windshield 140 of the vehicle 100. Thus, the front hinge 1110 moves the hood 120 of the vehicle 100 upwardly and rearwardly relative to the body 110 of the vehicle 100 when the front hinge 1110 moves from the collapsed position to the extended position, as shown in FIGS. 2A and 2B. The two rear hinges 1200 are also movable in an upward and rearward direction relative to the body 110 of the vehicle 100 as the front hinge 1110 moves from the collapsed position to the extended position, as shown in FIGS. 3A and 3B. Thus, the rear portion 124 of the hood 120 of the vehicle 100 is further from the portion of the body 110 of the vehicle 100 and closer to the windshield 140 of the vehicle 100 in the extended position than in the collapsed position.

In other implementations, the length between the first hinged connection and the second hinged connection is selected such that, when the hinge plates 1120, 1140, 1160 move from the collapsed position to the extended position, the second portion of the third hinge plate moves more than 100 mm in a direction perpendicular to the first longitudinal axis and more than 50 mm in a direction parallel to the first longitudinal axis in the direction of the windshield 140 of the vehicle 100. In other implementations, the length between the first hinged connection and the second hinged connection is selected such that, when the hinge plates 1120, 1140, 1160 move from the collapsed position to the extended position, the second portion of the third hinge plate moves at least 150 mm in a direction perpendicular to the first longitudinal axis and at least 100 mm in a direction parallel to the first longitudinal axis in the direction of the windshield 140 of the vehicle 100.

As the third hinge plate 1160 moves away from and in a direction parallel to the first longitudinal axis 1130 and the rear hinges 1200 move upwardly and rearwardly relative to the body 110 of the vehicle 100, the hood 120 is moved away from the engine 130 of the vehicle 100 and toward the cowl 142 of the windshield 140 of the vehicle 100. This movement accomplishes three benefits over the prior art.

First, the hood or the vehicle is lifted away from the engine of the vehicle. When a pedestrian is struck by a bumper of a vehicle, the collision can cause the pedestrian to be forced onto the hood of the vehicle. In its normal position, the hood of the vehicle is disposed a short distance from the engine. Because the hoods of most vehicles are relatively thin, a pedestrian forced onto a hood disposed in the normal position will deform the hood of the vehicle, and the pedestrian can contact the much harder engine of the vehicle through the deformed hood. The contact with the engine of the vehicle can cause significant injury to the pedestrian. When the hood of the vehicle is lifted away from the engine by one of the hood lifting assemblies disclosed herein, the pedestrian is less likely to deform the hood of the vehicle enough to contact the engine.

Second, when the hood lifting assemblies disclosed herein are actuated, the leading edge of the hood of the vehicle is moved toward the cowl of the windshield. If the hood of the vehicle were lifted vertically away from the engine of the vehicle without rearward movement, as practiced in the prior art, then the leading edge of the hood would be disposed near the front of the vehicle. In this situation, the head of a child or small person struck by the bumper of the vehicle could strike the leading edge of the hood. The leading edge of the hood is typically less deformable than other portions of the hood, which can cause severe injury to the child or small person. By moving the leading edge of the hood rearwardly as it is lifted upwardly away from the engine, the leading edge of the hood is disposed far enough away from the front of the vehicle such that a child or small person is less likely to strike their head on the leading edge of the hood in the event of a collision.

Third, the trailing edge of the hood of the vehicle is moved toward the cowl of the windshield. If the hood of the vehicle were lifted upwardly away from the engine of the vehicle without rearward movement, then the cowl of the windshield would be exposed. Because a bicycle typically positions a cyclist higher than a pedestrian, a cyclist typically contacts a farther rearward portion of the top of the vehicle than a pedestrian struck by the same vehicle. The cowl of the windshield is relatively harder than the windshield or the hood of the vehicle and can cause significant injury to a person if the person contacts the cowl in the event of a collision. By moving the trailing edge of the hood rearwardly as it is lifted upwardly away from the engine, the trailing edge of the hood covers the cowl of the windshield, preventing a person from contacting the cowl of the windshield during a collision.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” and “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

What is claimed is:

1. A hood lifting front hinge, the front hinge comprising:
a first hinge plate having a first portion and a second portion spaced apart and opposite the first portion along a first longitudinal axis;
a second hinge plate having a first portion and a second portion spaced apart and opposite the first portion of the second hinge plate along a second longitudinal axis, wherein the first portion of the first hinge plate is hingedly coupled to the first portion of the second hinge plate to form a first hinged connection; and
a third hinge plate having a first portion and a second portion spaced apart and opposite the first portion of the third hinge plate along a third longitudinal axis, wherein the second portion of the second hinge plate is hingedly coupled to the second portion of the third hinge plate to form a second hinged connection,
wherein the first hinge plate, the second hinge plate, and the third hinge plate are hingedly movable from a collapsed position to an extended position, wherein in the collapsed position the first longitudinal axis and the second longitudinal axis are at a minimum angle to each other, and in the extended position the first longitudinal axis and the second longitudinal axis are at a maximum angle to each other, wherein the maximum angle is greater than the minimum angle, and
wherein the first hinge plate is couplable to a portion of a hood latch of a vehicle and the third hinge plate is couplable to a portion of a hood of a vehicle, and the hood of the vehicle is further from the hood latch and closer to a windshield of the vehicle when the hinge plates are in the extended position than when the hinge plates are in the collapsed position.

2. The front hinge of claim 1, wherein the first hinge plate further comprises a latch mounting portion structured for mounting the front hinge to the portion of the hood latch.

3. The front hinge of claim 1, wherein the third hinge plate further comprises a hood mounting portion structured for mounting the front hinge to the hood of the vehicle.

4. The front hinge of claim 1, wherein at least two of the first hinge plate, the second hinge plate, and the third hinge plate include a temporary connector coupling the at least two of the first hinge plate, the second hinge plate, and the third hinge plate in the collapsed position, wherein the temporary connector is uncoupled when the first hinge plate, the second hinge plate, and the third hinge plate are moved from the collapsed position to the extended position.

5. The front hinge of claim 4, wherein the temporary connector is a rivet.

6. The front hinge of claim 1, wherein a length between the first hinged connection and the second hinged connection is selected such that the second portion of the third hinge plate is at least 100 mm away from the first longitudinal axis and is at least 50 mm parallel to the first longitudinal axis when the first, second, and third hinge plates are moved from the collapsed position to the extended position.

7. The front hinge of claim 6, wherein the length between the first hinged connection and the second hinged connection is selected such that the second portion of the third hinge plate is at least 150 mm away from the first longitudinal axis and is at least 100 mm parallel to the first longitudinal axis when the first, second, and third hinge plates are moved from the collapsed position to the extended position.

8. A front hinge actuation system comprising the front hinge of claim 1 and an actuator for moving the first hinge plate, the second hinge plate, and the third hinge plate from the collapsed position to the extended position.

9. A hood lifting assembly, the assembly comprising:
a single hood lifting front hinge, the front hinge comprising:
a first hinge plate having a first portion and a second portion spaced apart and opposite the first portion along a first longitudinal axis,
a second hinge plate having a first portion and a second portion spaced apart and opposite the first portion of the second hinge plate along a second longitudinal axis, wherein the first portion of the first hinge plate is hingedly coupled to the first portion of the second hinge plate to form a first hinged connection, and
a third hinge plate having a first portion and a second portion spaced apart and opposite the first portion of the third hinge plate along a third longitudinal axis, wherein the second portion of the second hinge plate is hingedly coupled to the second portion of the third hinge plate to form a second hinged connection,
wherein the first hinge plate, the second hinge plate, and the third hinge plate are hingedly movable from a collapsed position to an extended position, wherein in the collapsed position the first longitudinal axis and the second longitudinal axis are at a minimum angle to each other, and in the extended position the first longitudinal axis and the second longitudinal axis are at a maximum angle to each other, wherein the maximum angle is greater than the minimum angle, and
wherein the first hinge plate is couplable to a portion of a hood latch of a vehicle and the third hinge plate is couplable to a portion of a hood of a vehicle, and the hood of the vehicle is further from the hood latch and closer to a windshield of the vehicle in the extended position than in the collapsed position; and
two hood lifting rear hinges each comprising at least three rear hinge plates, wherein each of the at least three rear hinge plates is hingedly coupled to at least one of the others of the at least three rear hinge plates, wherein one of the at least three rear hinge plates is couplable to a portion of a body of the vehicle and another of the at least three rear hinge plates is couplable to a rear portion of the hood of the vehicle such that the rear portion of the hood of the vehicle is further from the portion of the body of the vehicle and closer to the windshield of the vehicle in the extended position than in the collapsed position.

10. The assembly of claim 9, wherein the assembly further comprises a hood latch, and the portion of the hood latch to which the first hinge plate is couplable is a striker.

11. The assembly of claim 9, wherein the first hinge plate further comprises a latch mounting portion structured for mounting the front hinge to the portion of the hood latch.

12. The assembly of claim 9, wherein the third hinge plate further comprises a hood mounting portion structured for mounting the front hinge to the hood of the vehicle.

13. The assembly of claim 9, wherein at least two of the first hinge plate, the second hinge plate, and the third hinge plate include a first temporary connector coupling the at least two of the first hinge plate, the second hinge plate, and the third hinge plate in the collapsed position, wherein the first temporary connector is uncoupled when the first hinge plate, the second hinge plate, and the third hinge plate are moved from the collapsed position to the extended position.

14. The assembly of claim 13, wherein the first temporary connector is a rivet.

15. The assembly of claim 9, further comprising an actuator for moving the first hinge plate, the second hinge plate, and the third hinge plate from the collapsed position to the extended position.

16. The assembly of claim 9, wherein a length between the first hinged connection and the second hinged connection is selected such that the second portion of the third hinge plate is at least 100 mm away from the first longitudinal axis and is at least 50 mm parallel to the first longitudinal axis when the first, second, and third hinge plates are moved from the collapsed position to the extended position

17. The assembly of claim 16, wherein the length between the first hinged connection and the second hinged connection is selected such that the second portion of the third hinge plate is at least 150 mm away from the first longitudinal axis and is at least 100 mm parallel to the first longitudinal axis when the first, second, and third hinge plates are moved from the collapsed position to the extended position.

18. The assembly of claim 9, wherein the one of the at least three rear hinge plates of each of the two hood lifting rear hinges is hingedly couplable to the portion of the body of the vehicle.

19. The assembly of claim 9, wherein at least two of the at least three rear hinge plates of each of the two hood lifting rear hinges include a second temporary connector coupling the at least two of the at least three rear hinge plates in the collapsed position, wherein the second temporary connector is uncoupled when the first hinge plate, the second hinge plate, and the third hinge plate are moved from the collapsed position to the extended position.

20. The assembly of claim 19, wherein the second temporary connector is a rivet.
